(19) United States
(12) Patent Application Publication
(10) Pub. No.: US 2026/0151749 A1
(43) Pub. Date: Jun. 4, 2026

(54) AN APPARATUS FOR MIXING AND DISCHARGING MATERIALS

(71) Applicant: VESPER DESIGN LIMITED, Boylestone Derbyshire (GB)

(72) Inventor: Roger Woolley, Boylestone Derbyshire (GB)

(21) Appl. No.: 19/126,774

(22) PCT Filed: Sep. 29, 2023
(86) PCT No.: PCT/GB2023/052524

§ 371 Date: May 2, 2025

(30) Foreign Application Priority Data
Nov. 4, 2022 (GB) 2216491.7

(51) Int. Cl. B01F 35/52; B01F 35/71; B01F 35/75; B01F 101/00

(52) U.S. Cl. CPC B01F 35/522; B01F 35/7131; B01F 35/7137; B01F 35/75425; B01F 2101/2305

(57) ABSTRACT

An apparatus for mixing and discharging materials, the apparatus comprising: a container comprising a first portion for containing a first material, and a second portion for containing a second material; a divider for dividing the first portion and the second portion; and means for mixing configured to mix said first material and said second material to form a mixed material.

### TECHNOLOGICAL FIELD

Embodiments of the present disclosure relate to an apparatus for mixing and discharging materials, not least curable materials, and a fixing apparatus for use with the same. Some embodiments relate to an apparatus for mixing and discharging curable materials for use with fastening an object to a wall. In other embodiments, the apparatus for mixing and discharging materials, not least curable materials, can be used in other fields, not least such as medicine.

### BACKGROUND

Components of curable materials, such as resins and hardeners, can be hazardous to both the user and the environment until the components are fully mixed and cured in the correct way, at the correct ratio. Conventional apparatuses for mixing and discharging materials are suboptimal in this regard, because they leave waste/unmixed components as residue, which may be considered hazardous. There is a therefore a desire/need for an improved apparatus for mixing and discharging materials.

The listing or discussion of a prior-published document or any background in this specification should not necessarily be taken as an acknowledgement that the document or background is part of the state of the art or is common general knowledge. One or more examples/aspects/embodiments of the present disclosure may or may not address one or more of the background issues.

### BRIEF SUMMARY

According to various, but not necessarily all, examples there is provided an apparatus for mixing and discharging materials, the apparatus comprising: a container comprising a first portion for containing a first material, and a second portion for containing a second material; a divider for dividing the first portion and the second portion, wherein the divider is further configured to separate into a first separated portion and a second separated portion; means for mixing configured to mix said first material and said second material to form a mixed material; and a plunger configured: to be movable relative to the container so as to reduce a volume of the container thereby causing said mixed material to be discharged from the container, and to be rotatable relative to the container.

According to various, but not necessarily all, examples there is provided examples as claimed in the appended claims.

The following portion of this ‘Brief Summary’ section, describes various features that may be features of any of the examples described in the foregoing portion of the ‘Brief Summary’ section. The description of a function should additionally be considered to also disclose any means suitable for performing that function

The plunger may be configured to be engageable with a first portion of the divider such that a rotation of the plunger with respect to the container enables co-rotation of the first portion of the divider with the plunger.

A second portion of the divider may be configured to be engageable with the container such that the second portion of the divider is fixed with respect to the container.

The plunger may comprise means for locating the plunger with respect to the container.

The plunger may further comprise a spindle.

The divider may further comprise a detachable member configured to at least one of: receive and locate an end of the spindle; and detach from the divider in response to an application of a force, by a user via the spindle, to the detachable member.

At least a portion of the divider may be configured to be at least one of: movable relative to the container; rotatable relative to the container; and translatable relative to the container.

The divider may be configured to at least one of: separate when a torsion in the divider reaches a predetermined threshold; and separate responsive to a rotation of the plunger.

The divider may be configured such that, when the plunger is engaged with the divider and when the divider is engaged with the container, upon application of torsion beyond a predetermined threshold, the divider separates into the first and second separated portions.

The divider may comprise one or more of: a frangible portion; a weakened portion; a glued portion; a perforated line.

The means for mixing may be at least one of the first and second separated portions. The means for mixing may be one or more mixing members having a shape at least partially defined by the one or more of: the frangible portion; the weakened portion; the glued portion; the perforated line.

The divider may be further configured to be collapsible.

The container may further comprise an elongate member configured to be received and located into an elongate cavity.

The elongate member may define a conduit for passage of said mixed material therethrough, and wherein the conduit may comprise one or more conduit outlets to allow discharge of said mixed material therefrom.

The elongate member may further comprise holding means configured to, in use when the elongate member is received and located in said elongate cavity, removably hold the elongate member in a held state within said elongate cavity, wherein the held state resists motion of the elongate member in a direction along a major axis within said elongate cavity.

The holding means may be further configured to, in use when the elongate member is received and located in said elongate cavity, be rotatable about said axis within said elongate cavity when the elongate member is in the held state.

The apparatus for mixing and discharging materials may further comprise at least one of: the first material; the second material; and the mixed material.

The apparatus for mixing and discharging materials, wherein at least one of: said first material may comprise a hardener; and said second material may comprise one or more of an epoxy resin; a resin; a polymer; and said mixed material may comprise one or more of a non-settable material; a settable material; a curable material; a resin; an adhesive medium; a fluid; an expanding fluid; a glue; an expanding glue; expanding foam; a medicinal substance.

According to various, but not necessarily all, examples there is provided examples as claimed in the appended claims.

### BRIEF DESCRIPTION

Some examples will now be described with reference to the accompanying drawings in which:

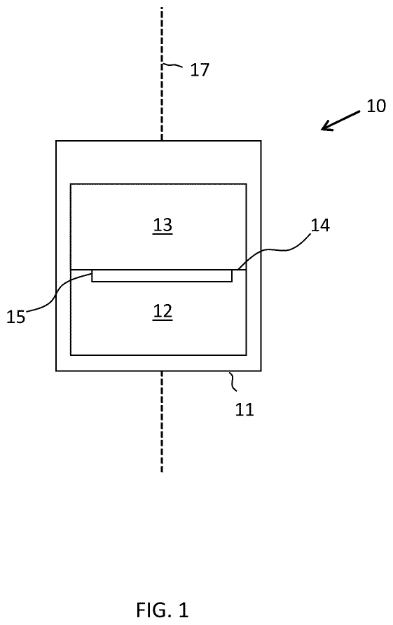

FIG. 1 shows a schematic example of the subject matter described herein;

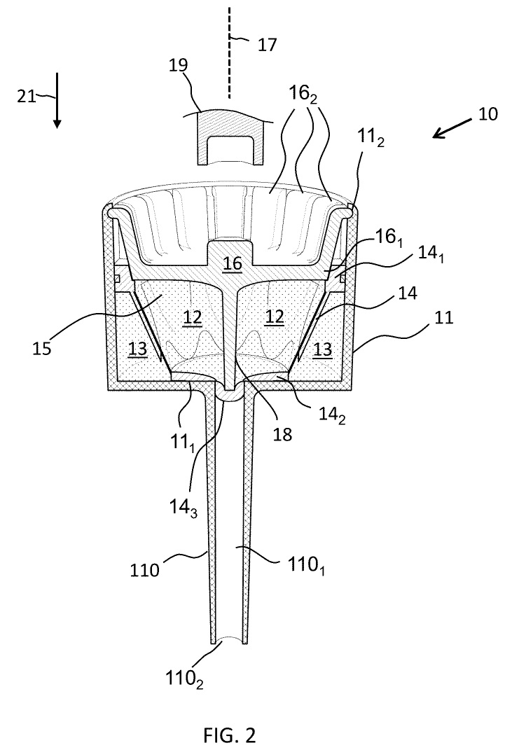

FIG. 2 shows an example of the subject matter described herein;

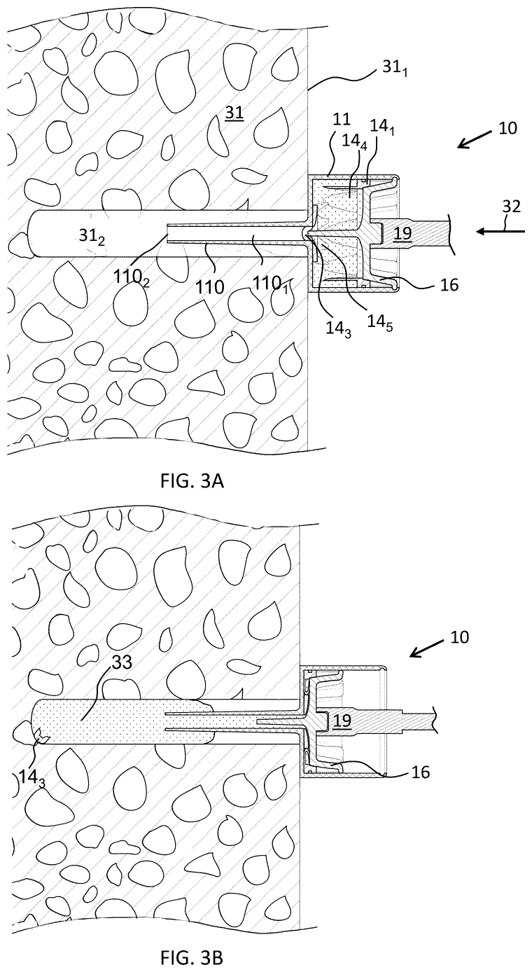

FIGS. 3A to 3C show examples of the subject matter described herein;

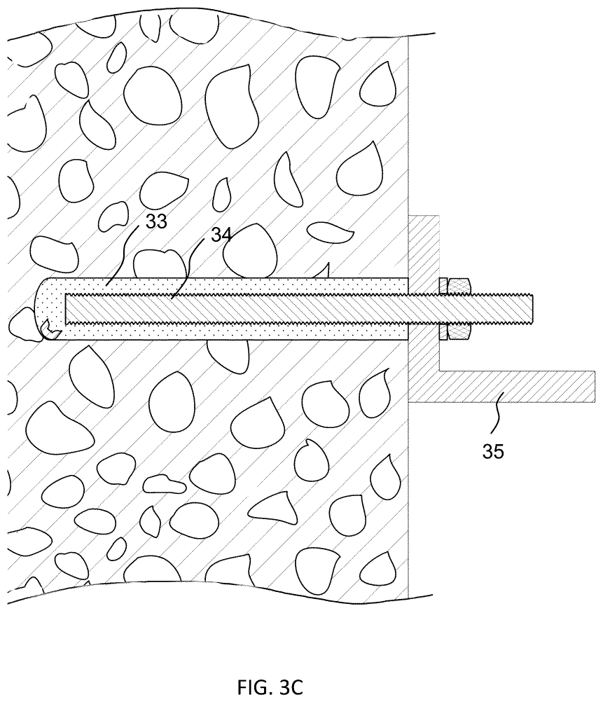

FIGS. 4A to 4C show schematic examples of the subject matter described herein;

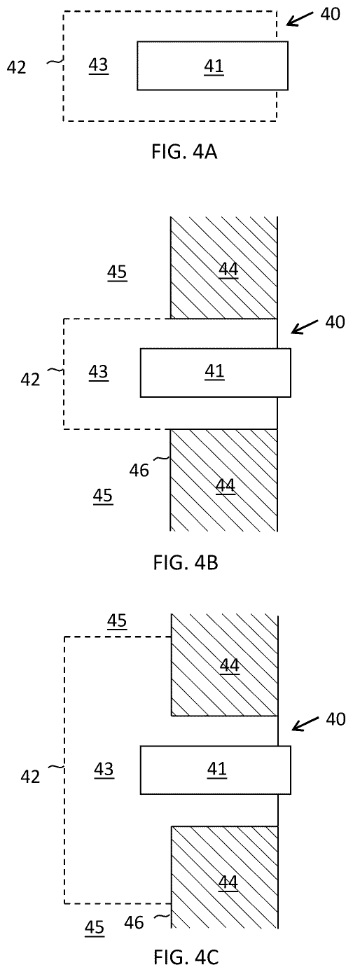

FIGS. 5A and 5B show examples of the subject matter described herein;

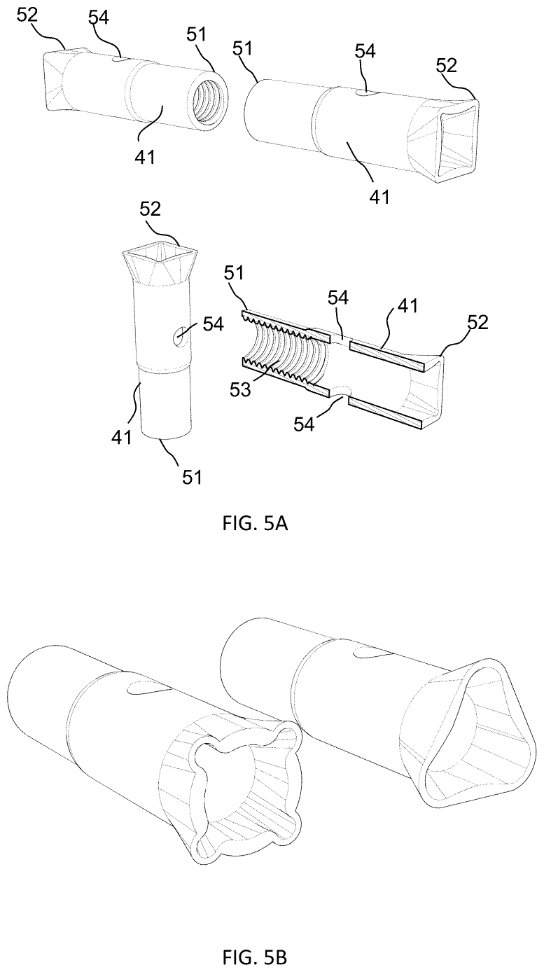

FIG. 6 shows an example of the subject matter described herein;

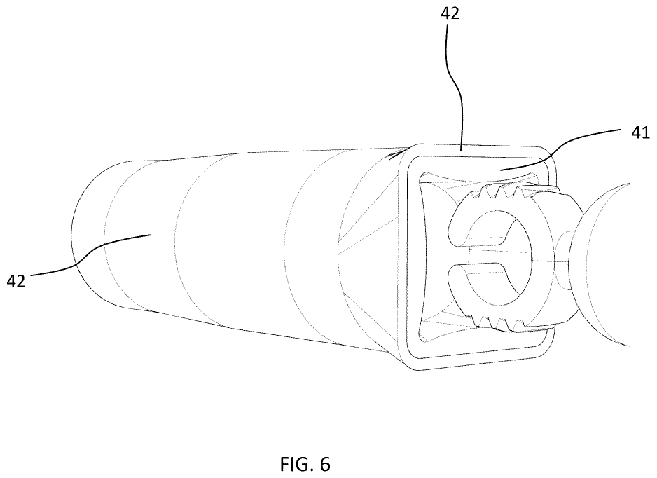

FIG. 7 shows an example of the subject matter described herein;

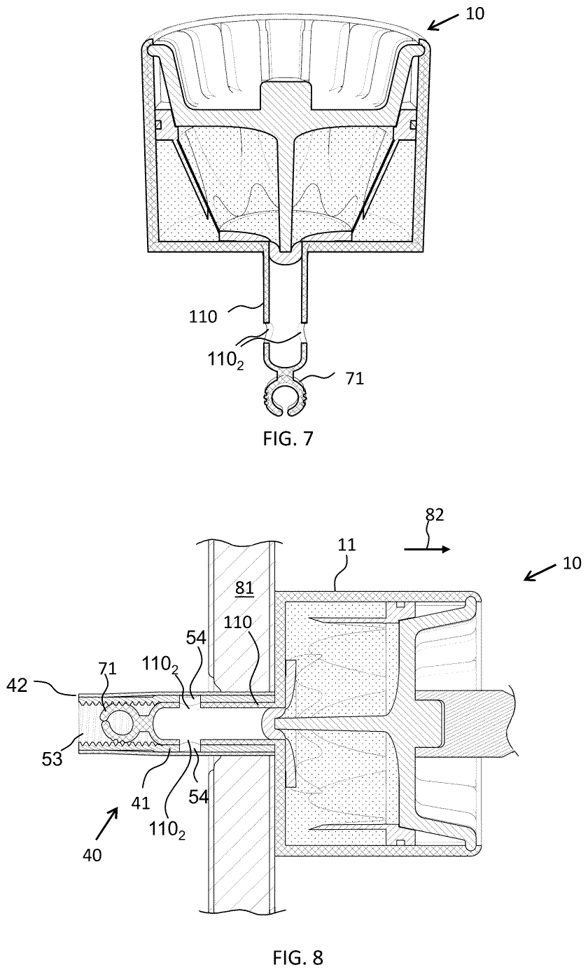

FIG. 8 shows an example of the subject matter described herein;

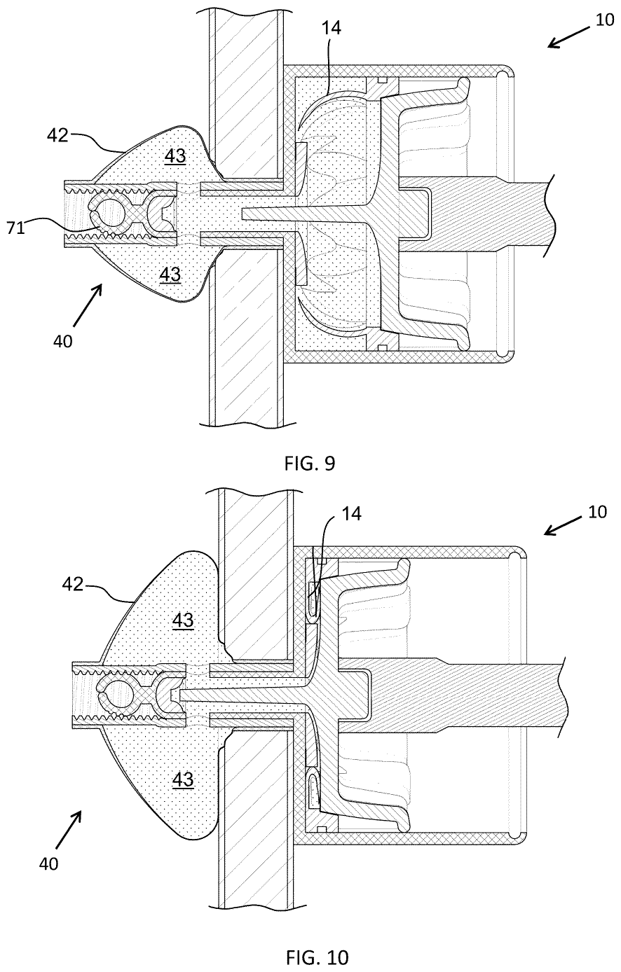

FIG. 9 shows an example of the subject matter described herein;

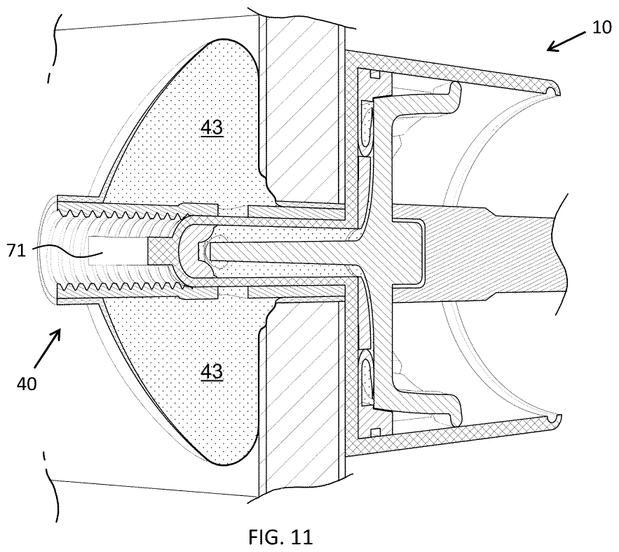

FIG. 10 shows an example of the subject matter described herein;

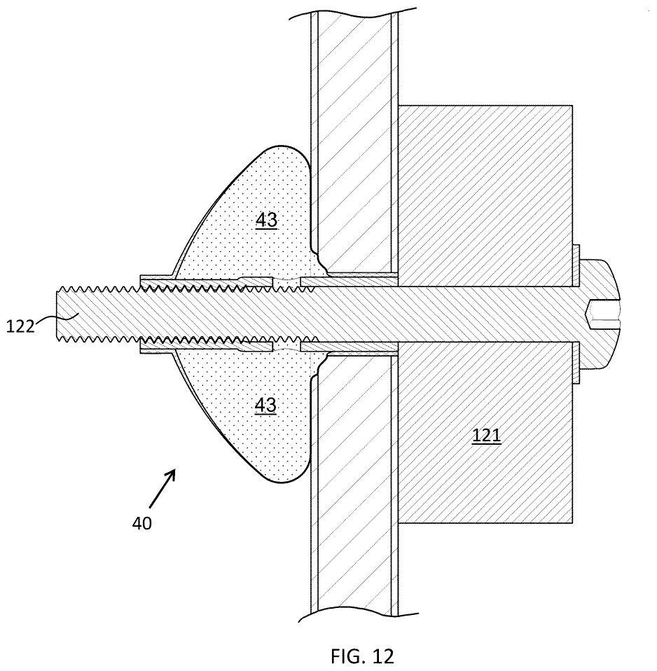

FIG. 11 shows an example of the subject matter described herein;

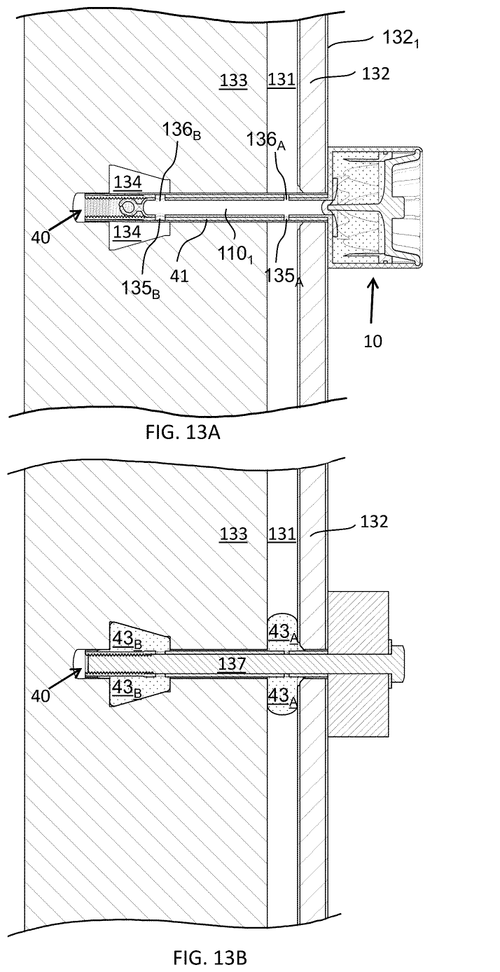

FIG. 12 shows an example of the subject matter described herein; and

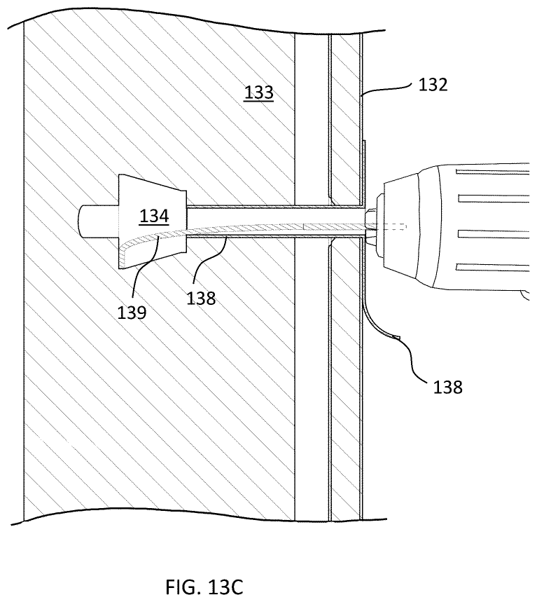

FIGS. 13A, 13B, and 13C show examples of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

FIG. 1 shows a schematic view of an example of the disclosure relating to an apparatus 10 for mixing and discharging materials. The apparatus 10 comprises a container 11 comprising a first portion 12 for containing a first material, and a second portion 13 for containing a second material. The apparatus 10 further comprises a divider 14 for dividing the first portion 12 and the second portion 13, and means for mixing 15 configured to mix said first material and said second material to form a mixed material. In some examples, there may be further portions for containing further materials.

The container 11 can be for containing materials. The container 11 can have a substantial bowl-shape, or a ‘U’ shape. The container 11 can also be for containing the first material and the second material while they are being mixed together by the means for mixing 15 to form the mixed material. The container 11 can be made from a transparent material (for example, transparent plastic) to allow a user to observe the mixing process.

The divider 14 is configured to divide the first portion 12 and the second portion 13, and is therefore configured to divide the first material and the second material. In some examples the divider 14 can be configured to separate. The divider 14 may define the first portion 12 and the second portion 13. For example, the divider 14 can be a wall. The divider 14 can be formed from, for example, silicone, plastic, film, or foil.

The means for mixing 15 can be for mixing said first material and said second material together. The mixing process may take place after the divider has separated. The mixing process can take place inside the container 11. The means for mixing 15 can mix the first material and the second material together by rotating relative to the container 11. The rotation can be about an axis 17.

In some, but not necessarily all, examples the means for mixing 15 can be rotated by coupling the means for mixing 15 to a rotating driving means (for example, a drill).

The apparatus 10 can be for mixing and discharging materials for receipt by any other apparatus, for example a fixing apparatus (or any other apparatus in any other field of use, not least for example, medical use).

FIG. 2 shows a sectional view of an example of the apparatus 10 comprising a container 11, a first portion 12 for containing a first material, and a second portion 13 for containing a second material, a divider 14 for dividing the first portion 12 and the second portion 13, and means for mixing 15 configured to mix said first material and said second material to form said mixed material.

In some, but not necessarily all, examples, the apparatus 10 may further comprise a plunger 16. The container 11 can be at least partially bounded by the plunger 16, that is, the plunger 16 and the container 11 can form a closed volume. The closed volume can be substantially air tight. The mixing process can take place inside the closed volume.

In some examples, the plunger 16 and the divider 14 may be integrally formed/formed as a single piece/component.

In some examples, the plunger 16 and the divider 14 can form a closed volume. This closed volume may define one of the first and second portions. This closed volume can be substantially air tight. In this example, one or more components of the apparatus 10, not least the divider 14 and/or the plunger 16, may be resistant to ultraviolet (UV) light (i.e., resistant to UV light penetrating each of the divider 14 and/or the plunger 16). Accordingly, in this example, the closed volume defined by the plunger 16 and the divider 14 can be protected/shielded from UV light. Advantageously, one of the first or second materials contained in this closed volume can be protected/shielded from UV light (e.g., to prevent premature curing/hardening).

In some examples, the divider 14 and the container 11 can form a closed volume. This closed volume may define the other of the first and second portions. This closed volume can be substantially air tight.

The plunger 16 may be configured to be movable relative to the container 11 so as to reduce the closed volume of the container 11 and/or the first portion and/or the second portion, thereby causing said mixed material to be discharged from the container 11. The plunger 16 may to be rotatable relative to the container 11. The plunger 16 therefore may function as both a plunger (and/or piston) and/or a rotor.

The plunger 16 may be configured to be engageable with a first portion 141 of the divider 14 such that a rotation of the plunger 16 with respect to the container 11 enables co-rotation of the first portion 141 of the divider 14 with the plunger 16.

A second portion 142 of the divider 14 may be configured to be engageable with the container 11 such that the second portion 142 of the divider 14 is fixed with respect to the container 11.

For example, the second portion 142 of the divider 14 can be adhered (for example, glued) to a portion 111 of the container 11, and the first portion 141 of the divider 14 can be adhered (for example, glued) to a portion 161 of the plunger 16. Therefore, if the plunger 16 is rotated with respect to the container 11, first portion 141 moves/co-rotates with the plunger, and second portion 142 is fixed with respect to the container 11. Accordingly, upon the rotation of the plunger 16 with respect to the container 11, the divider 14 is put under torsion and/or tension and/or force. Accordingly, if this torsion and/or tension and/or force exceeds a predetermined threshold, the divider will separate.

In this regard, the divider 14 may be configured such that, when the plunger 16 is so engaged with the first portion 141 of the divider 14 and when the second portion 142 of the divider 14 is engaged with the container 11, upon application of torsion and/or tension and/or force beyond a predetermined threshold in/on the divider 14, the divider 14 separates into the first and second separated portions 144 and 145. In some examples, the divider may separate into more than two separated portions.

The divider 14 may be configured to separate into a first separated portion and a second separated portion (shown, for example, after separation in FIG. 3A with numerals 144 and 145). The divider 14 being configured to separate can be the divider 14 being configured to be torn. The divider 14 being configured to separate can, not least for example, comprise the divider 14 comprising one or more of: a frangible portion; a weakened portion; a glued portion; a perforated line. Upon rotation of the plunger 16, the resulting torsion and/or tension and/or force in/on the divider 14 causes the divider 14 to separate, for example, along the one or more of: frangible portion; weakened portion; glued portion; perforated line.

In some, but not necessarily all, examples the plunger 16 can be rotated by coupling the plunger 16 to a rotating driving means (for example, a drill). The plunger 16 may have means for engaging with the driving means. For example, the means for engaging may comprise a component to intermesh/lock with a complementary component on the rotating driving means such that rotation of the driving means induces rotation of the plunger 16.

The plunger 16 can move relative to the container 11 in direction 21 such that the closed volume decreases. The direction 21 is a direction towards the first portion 12 and second portion 13 of the container 11. The plunger 16 can move responsive to a user applying a force to the plunger (e.g., via the rotating driving means) in direction 21. Decreasing the closed volume increases the pressure within the closed volume. Once a threshold pressure is reached, materials within the closed volume are discharged from the closed volume.

The plunger 16 may comprise means for locating 162 the plunger 16 with respect to the container 11. The means for locating 162 the plunger 16 may be configured to maintain a position of the plunger 16 relative to the container 11 up to a predetermined threshold of a force applied to the plunger 16 (e.g., by the user via the rotating driving means) in direction 21. If a force beyond this predetermined threshold is applied to the plunger 16 in direction 21, the plunger may move relative to the container 11 so as to reduce the closed volume of the container 11 (as previously described).

In this regard, in some, but not necessarily all, examples, the plunger 16 can spin and/or rotate with respect to the container 11. In this example, the means for locating 162 the plunger 16 comprises at least one clip/runner which is configured to slot into a groove/track 112 in the container 11. In use, as previously described, a user can couple the plunger 16 to a drill bit, not least for example, a 20 mm drive bit and/or a hex drive bit. Upon coupling to the plunger 16 and rotation of the drill bit, the plunger 16 rotates about axis 17, and the at least one clip/runner travels along/through the groove/track 112, thereby maintaining the position of the plunger 16 relative to the container 11.

In some, but not necessarily all, examples, the plunger 16 may further comprise a spindle 18. The spindle 18 can be in the center of the container 11, and lies along the axis 17, which may be the same as the axis of rotation of the plunger 16. The spindle 18 can be formed integrally with the plunger 16. The spindle 18 may aid maintenance of a position/orientation of the plunger 16.

In some, but not necessarily all, examples, the divider 14 further comprises a detachable member 143 configured to at least partially detach/separate/break away from the divider 14 in response to an application of a force over a predetermined threshold and/or an internal pressure inside the container 11 over a predetermined threshold (e.g., via hydrodynamic and/or pneumatic and/or hydraulic processes). In some, but not necessarily all, examples, the detachable member 14₃ is further configured to receive and locate an end of the spindle 18. In some examples, said force may be provided by a user via the spindle 18, to the detachable member 14₃. For example, the force could be applied by the user via a drill bit 19 coupled to the plunger 16. In some examples, said internal pressure may be provided by the plunger 16 moving responsive to a user applying a force to the plunger as previously described.

The detachable member 14₃ may be a sub-portion of the second portion 14₂ of the divider 14, wherein the second portion 14₂ itself may be configured to be engageable with the container 11 (as previously described). The detachable member 14₃ of the divider 14 may, prior to detachment, be alignable with an outlet/aperture/hole in the container 11 such that, prior to detachment, the detachable member 14₃ of the divider effectively acts as a plug/stop/seal, preventing egress/discharge of material from the container. Accordingly, the detachment/separation/break of the detachable member 14₃ from the divider 14 may define an outlet for any material contained within the container 11 to flow therethrough. Said outlet leads to a conduit 110₁ in an elongate member 110.

In some examples, instead of comprising the detachable member 14₃, the divider 14 may comprise an exit aperture/hole configured to be sealable/pluggable by a distal end of the spindle 18. The distal end may be an end of the spindle 18 configured to seal/plug the exit aperture/hole. In this example, the aperture/hole may be configured to be unsealed/unplugged (to allow flow of material inside the container 11 therethrough) responsive to an application of a force via the spindle 18 over a predetermined threshold such that the distal end of the spindle 18 moves away from the exit aperture/hole. For example, the force could be applied by the user via a drill bit 19 coupled to the plunger 16. In this example, the spindle 18 may have a cross-sectional area which tapers/decreases along its length such that the spindle 18 has a larger cross-sectional area at a distal end than a proximal end.

In some, but not necessarily all, examples, the apparatus 10 can comprise an elongate member 110 configured to be received and located and/or inserted into an elongate cavity (e.g., a through-hole, or a blind hole, a threaded elongate cavity, or the like). The elongate member 110 can be an alignment member for aligning the apparatus 10 with the elongate cavity. The elongate member 110 can be formed integrally to the container 11. The elongate member may be longitudinal, and may define a major axis of the apparatus 10.

The elongate member 110 may define a conduit 110₁ for passage of said mixed material therethrough. The conduit 110₁ may allow for passage of material from the container 11, e.g., via the outlet defined by the detachment of the detachable member 14₃ from the divider 14. Prior to use, passage of material from the container 11 into the conduit 110₁ is blocked/plugged/prevented/impeded by the detachable member 14₃. The detachment/separation/break of the detachable member 14₃ from the divider 14 may define an outlet for said mixed material to flow through into the conduit 110₁. The conduit 110₁ may be a passageway having walls, through which said mixed material can flow.

The conduit 110₁ may comprise one or more conduit outlets 110₂ to allow discharge of said mixed material therefrom. In this example, the one or more conduit outlets 110₂ may be located at an end of the elongate member 110, e.g., an end distal to the container 11. In this example, the one or more conduit outlets 110₂ may be a single outlet.

FIGS. 3A-3C show sectional views of the example apparatus 10 during different stages of use for fixing a load to a wall (although, as mentioned previously, the applicant envisions different uses for the apparatus 10, not least medical uses).

In use, a user drills an elongate cavity 312 (e.g., a blind hole) into a substrate 31 (e.g., plasterboard, brick wall, breeze block etc.). The user then locates the container 11 of the apparatus 10 against the surface 311 of a substrate 31 by inserting the elongate member 110 into the elongate cavity 312 in the substrate 31.

The user then, as mentioned previously, couples a rotating driving means 19 (for example, a drill) to the plunger 16. Rotation of the plunger 16 with the driving means causes divider 14 to separate responsive to the rotation of the plunger 16 with respect to the container 11 as described previously. Alternatively, the user may perform this step prior to the user locating the container 11 of the apparatus 10 against the surface 311 of the substrate 31 and/or inserting the elongate member 110 into the elongate cavity 312 of the substrate 31.

FIG. 3A shows a sectional view of upon separation of the divider 14. The divider 14 may be configured to separate into a first separated portion 14₄ and a second separated portion 14₅. In some, but not necessarily all, examples the means for mixing are at least one of the first and second separated portions, for example the first separated portion 14₄. The means for mixing therefore may comprise mixing blades and/or mixing members having a shape at least partially defined by the one or more of: the frangible portion; the weakened portion; the glued portion; the perforated line.

Upon separation of the divider 14, the first material in the first portion 12 and the second material in the second portion 13 are able to mix together inside the container 11. The mixing of the first material and the second material together is aided by the means for mixing (e.g., which may be the first separated portion 14₄ of the divider).

The portion 14₁ of the divider may be engageable with the plunger 16 (as previously mentioned). Therefore, when the portion 14₁ of the divider is so engaged, continued rotation of the plunger 16 may cause the first separated portion 14₄ of the divider, and therefore the means for mixing, to rotate through the (now non-separated) first material and second material, thereby helping to mix the first material and the second material together to form the mixed material.

In some, but not necessarily all, examples, as the plunger 16 rotates, the first separated portion 144 of the divider, and therefore the means for mixing, moves through the first and second materials, generating frictional heating within the first and second materials. Higher rotational speeds (e.g., rotational speeds achieved by a drill) may generate higher frictional heating. This heating can aid the mixing process and/or the curing process and/or a chemical reaction between the first and second materials to form the mixed material from the first and second materials. One or both of the first material and the second material can further comprise temperature-dependent and/or consistency-dependent chemical markers configured to change the colour of the resulting mixed material to indicate to a user when the mixed material is at an ideal temperature and/or consistency. In this context, ideal consistency means at a consistency ideal for delivery into, and use within, a fixing apparatus for fixing a load to a wall (although, as mentioned previously, the applicant envisions different uses for the apparatus 10, not least medical uses). A threshold temperature of the mixed material being reached is indicative of the ideal consistency being reached.

At least one of the first and second material can be, for example, a hardener or the like. The other of the first and second material can be, for example, one or more of an epoxy resin; a resin; a polymer or the like. The mixed material can be, not least for example, any one or more of: a settable material; a curable material; a resin; an adhesive medium; a fluid; an expanding fluid; a glue; an expanding glue; expanding foam. The apparatus 10 can include the first material and the second material.

The first material and the second material can be selected to mix together to form a mixed material.

In some examples, the first portion and second portion (comprising the first and second materials) may have predetermined volumes such that a ratio and quantity of the volumes of the first material and second material is suitable for a specific application.

For example, the first portion and second portion (comprising the first and second materials) may have predetermined volumes (and accordingly the first material and second material have predetermined volumes) such that the first material and second material are fully/optimally mixed/used up/reacted/depleted after the mixing process. Advantageously, this results in minimized waste after use. As discussed previously, this waste may be considered to be hazardous, and, accordingly, this results in minimized hazardous waste. Hazardous waste generally needs to be incinerated, which results in carbon emissions. By avoiding the need to incinerate the waste, the apparatus accordingly advantageously enables a reduced carbon footprint.

For example, the first portion and second portion (comprising the first and second materials) may have predetermined volumes such that the volume of the resulting mixed material is suitable for a specific application. In the use case of using the apparatus 10 for fastening objects/loads to a wall, the first portion and second portion (comprising the first and second materials) may have volumes such that the volume of the resulting mixed material is substantially enough for a single typical load. Advantageously, this results in minimized wastage after use. Furthermore, mixing exact/predetermined volumes may have benefits when the apparatus 10 is used for the specific application in medical fields, for example, by providing exact dosages of medical materials/medication.

The user then applies a linear force to the plunger 16 in direction 32 (that is, towards the fixing apparatus 10 when in use). As previously described, if this force is beyond a predetermined threshold the plunger 16 moves in direction 32, thereby reducing the enclosed volume within the container 11 as previously described. The plunger 16 can move in direction 32 because the at least one clip/runner previously maintaining the position of the plunger 16 relative to the container 11 has unclipped from the groove 11₂ and/or broken free of the groove 11₂. The reduced volume in the container 11 accordingly increases the pressure of the now mixed material within the container 11.

As the user applies linear force to the plunger 16 in direction 32, the spindle 18 may accordingly move in direction 32. As previously described, an end of the spindle 18 is configured to be received and located into the detachable member 14₃ of the divider 14. Therefore, the linear force applied to the plunger 16 in direction 32 applies a force to the detachable member 14₃ of the divider 14 via the spindle 18. This causes the detachable member 14₃ of the divider 14 to detach/separate/break away from the divider 14, defining/opening an outlet for the mixed material to flow therethrough into the conduit 110₁ as previously described. The spindle 18 may be configured in its dimensions to not hinder/impede/block the flow of the mixed material from the outlet into the conduit 110₁ (e.g., the spindle 18 may have a diameter less than that of the outlet in the container 11).

The increased pressure within the container 11 accordingly urges the mixed material from the container 11, via the outlet, into the conduit 110₁ defined by the elongate member 110, through the conduit 110₁, and finally out of the one or more conduit outlets 110₂ (in this example there is a single conduit outlet). Because the elongate member 110 is received and located into the elongate cavity 31₂, the mixed material is accordingly discharged the from the one or more conduit outlets 110₂ and into the elongate cavity 31₂, as shown in FIG. 3B.

As demonstrated int FIG. 3B, the user can maintain the pressure (and therefore maintain flow of the mixed material 33 through the outlet) by continuing to move the plunger 16 in the direction 32. This can continue until the plunger 16 contacts a bottom of the container 11, as shown in FIG. 3B, wherein substantially all of the mixed material 33 has been discharged from the container 11 and into the elongate cavity 31₂. The detachable member 14₃ of the divider 14 may also be discharged from the apparatus 10 with the mixed material. In the use case where the mixed material is a curable resin, although trace amounts of mixed material will remain in the container 11, because this mixed material is fully mixed the discharged apparatus 10 will not be considered hazardous waste.

In some, but not necessarily all, examples, the divider 14 may be configured to be collapsible. For example, one or more side walls of the divider may be configured to be collapsible. An example of the divider 14 being in a partially collapsed state is shown in FIG. 9, and an example of the divider 14 being in a fully collapsed state is shown in FIG. 10. Advantageously, this allows for maximum compression of the volume within the container 11, thereby enabling the amount of the mixed material discharged from the apparatus 11 to be maximized.

At this stage, as demonstrated in FIG. 3C, the user can remove the apparatus 10 from the elongate cavity 312 by pulling on the apparatus 10. The user may then insert a fastener (e.g., a threaded bolt 34, e.g., an M6 bolt) into the not hardened/cured and/or yet fully hardened/fully cured mixed material 33 in the elongate cavity 312. Upon hardening/curing of the mixed material 33, the user may then attach a load 35 to the fastener. The hardened/cured/mixed material 33 advantageously strengthens/reinforces the attachment of the fastener to the substrate.

The apparatus 10 described thus far is suitable for use for fixing a load to a wall using a blind hole in the wall. In some, but not necessarily all, examples, the apparatus 10 may be used in conjunction with a fixing apparatus 40 for receiving a fastener to provide additional benefits such as, not least, fixing loads to through-holes in substrates (e.g., plasterboards) rather than blind holes in, e.g., brick walls as previously described.

FIG. 4A shows a schematic view of an example of the disclosure relating to a fixing apparatus 40 for receiving a fastener (not shown). The fixing apparatus 40 comprises a housing 41 for receiving said fastener, and an expandable membrane 42, wherein the fixing apparatus 40 is configured to receive a material (not least for example a material dispensed from the apparatus 10 as previously described) wherein the expandable membrane 42 is configured to expand responsive to receipt of said material thereby defining a chamber 43, wherein the chamber 43 is at least partially bounded by the expandable membrane 42 and the housing 41.

The fixing apparatus 40 can be suitable for insertion into an aperture/hole/through hole in a plasterboard 44, as shown in FIGS. 4B and 4C (shown with hatched lines). Plasterboards are commonly used in the construction of interior walls and are frequently set up in front of a brick wall (for example, breeze block, or other construction blocks) with a void 45 behind the plasterboard 44 between the plasterboard 44 and the brick wall (not shown). The expandable membrane 42 (shown with dashed lines) and the chamber 43 are configured such that, once the fixing apparatus 40 is inserted into the aperture/hole in the plasterboard 44 (as shown in FIGS. 4B and 4C), at least a portion of the expandable membrane 42 and at least a portion of the chamber 43 substantially extend from the rear surface 46 of the plasterboard 44 into the void 45 behind the plasterboard 44.

The fixing apparatus 40 can be formed in different sizes according to the magnitude of the load the fixing apparatus 40 is intended to support. The size of the fixing apparatus 40 in this instance corresponds to the size (for example, the diameter) of the aperture/hole in the plasterboard 44 required to tightly fit the apparatus 40, that is, tight enough such that the fixing apparatus 40 can support the load without being pulled from the aperture/hole. The size can be, not least for example: 12 mm; 16 mm; 20 mm, or any other size.

The fixing apparatus 40 can also be suitable for insertion into an aperture/hole in other mediums/substrates, such as not least for example, any of: fiber glass; Polyvinyl chloride (PVC); sheet metal; glass. References to plasterboard 44 in this description can be replaced with any of these mediums/substrates, and any other suitable medium/substrate.

The housing 41 is configured in its dimensions to receive a fastener (e.g., not least a threaded bolt). For example, the housing 41 can be substantially elongated. For example, the housing 41 can comprise an elongate cavity and/or comprise a threaded cavity having a thread. The housing 41 may be formed from one or more substantially rigid materials.

The expandable membrane 42 can comprise any suitable means for enabling the expandable membrane 42 to expand. For example, the expandable membrane 42 can be, not least for example, one or more of: a mesh; a skin; a sleeve; a weave. The expandable membrane 42 can be, not least for example, formed from one or more of: a polymer; an elastic material; a sponge material; a chain-link material; a fibrous material; a metal. One or more portions (for example, the edges) of the expandable membrane 42 can be sealed to the housing 41 by any suitable attachment means, for example, by one or more of: an adhesive medium; heat welding; or frictional coupling by threading/slotting/inserting the expandable membrane 42 into a groove in the housing 41.

In some, but not necessarily all, examples, the expandable membrane 42 of the fixing apparatus 40 can be permeable to the material. In some, but not necessarily all, examples, the expandable membrane 42 of the fixing apparatus 40 may have one or more portions permeable to the material. The expandable membrane 42 can be permeable on a proximal end of the expandable membrane 42. The expandable membrane 42 can have a permeability that varies along the expandable membrane 42 such that it is not permeable on a distal end of the expandable membrane 42 and is permeable on a proximal end of the expandable membrane 42. A proximal end of the expandable membrane 42 in this instance is an end of the expandable membrane 42 which, during use as a plasterboard fixing, is closest to the rear surface 46 of the plasterboard 44. A distal end of the expandable membrane 42 in this instance is an end of the expandable membrane 42 which, during use as a plasterboard fixing, is furthest from the rear surface 46 of the plasterboard 44. References to plasterboard 44 can be replaced with other mediums previously described. Permeable to the material in this instance means that, responsive to receipt of the material into the chamber 43, the material at least partially passes/leaks/oozes through the expandable membrane 42. This is advantageous for several reasons.

Firstly, it enables the material to fill any space between the external surface of the expandable membrane 42 and the rear surface 46 of the plasterboard 44, and accordingly set/cure/solidify such that the plasterboard 44 and the proximal end of the expandable membrane 42 (and therefore the fixing apparatus 40 itself) are mechanically or physically joined together.

Secondly, in the case where the material is an adhesive medium, it enables the external surface of the expandable membrane 42 to be adhered to the rear surface 46 of the plasterboard 44. Furthermore, it enables the material to fill in/mould to any damaged portions/irregularities of the plasterboard 44 formed as a result of forming the hole/aperture in the plasterboard 44 to receive the fixing apparatus 40 (for example, “blowout”). Both of these advantages result in the fixing apparatus 40 strengthening the plasterboard 44 after installation, whereas conventional plasterboard fixings do not overcome the issues previously mentioned and tend to weaken the plasterboard 44 after installation.

Thirdly, the expandable membrane may be enabled to attach/adhere to any nearby wooden/metal supports (or any other type of support) which may be located behind the plasterboard and are proximate to the drilled hole in the plasterboard.

Fourthly, conventional fixings can convey any load forces solely at their points of contact with the plasterboard, which can be very minimal and sharp. Accordingly, when, for example, a downward force is applied the only support which the plasterboard provides is direct reaction forces/resistance at these points of contact. Conventional fixings can therefore cut their way through the plasterboard. With examples of the fixing apparatus 40, when the material has adhesive properties, the fixing may be attached to/braced against a larger area of the plasterboard than conventional fixings and accordingly a larger amount of the plasterboard is providing resistance/support.

Fifthly, by allowing the material at least partially to pass/leak/ooze through the expandable membrane 42, the expandable membrane 42 becomes a support structure/scaffold to strengthen the cured/hardened mixed material.

In some, but not necessarily all, examples, the expandable membrane 42 of the fixing apparatus 40 can be flexible. In some, but not necessarily all, examples, the expandable membrane 42 of the fixing apparatus 40 may have one or more flexible portions. The expandable membrane 42 can be flexible on a proximal end of the expandable membrane 42. The expandable membrane 42 can have a flexibility that varies along the expandable membrane 42. The expandable membrane 42 can have a flexibility that varies from a minimum flexibility on a distal end of the expandable membrane 42 to a maximum flexibility on a proximal end of the expandable membrane 42. The expandable membrane 42 can have a flexibility that varies along the expandable membrane 42 such that the material is urged towards the proximal end of the expandable membrane 42. The resulting expanded chamber 43 accordingly lies against or close to the plasterboard 44. The expanded chamber 43 can therefore form an abutment surface against the plasterboard 44. In this instance, the expanded chamber 43 forming an abutment surface means that a part of the surface of the expanded chamber 43 abuts/lies against/braces against/leans on the rear surface 46 of the plasterboard 44. In some examples, the resulting expanded chamber 42 can then form a substantial disk shape. Advantageously, this allows a load applied to the fixing to be dispersed over the area of the rear surface 46 of the plasterboard 44 in contact with the abutment surface. The expandable membrane 42 being flexible has the further advantage of enabling the expandable membrane 42 to fill in or mold to any damaged portions of the plasterboard 44 formed as a result of forming the hole/aperture in the plasterboard 44 to receive the fixing apparatus 40. This results in the fixing apparatus 40 strengthening the plasterboard 44 after installation, whereas conventional plasterboard fixings tend to weaken the plasterboard 44 after installation.

The expandable membrane 42 can further comprise protrusions extending into the chamber 12, that is, the protrusions are internal protrusions. For example, the protrusions can be strands, filaments, or fibers. The protrusions can be formed from the same material/materials the expandable membrane 42 is formed from such that the protrusions are integral to the expandable membrane 42. Advantageously, once the chamber 43 has been substantially filled with the material (for example, in its expanded configuration), the material will surround the protrusions and accordingly set/cure/solidify surrounding the protrusions. The resulting “chamber-material-protrusion” structure is therefore a set/cured/solidified material with an internal structure or “skeleton” of protrusions. The resulting structure therefore has a higher strength and rigidity than one without the protrusions (and is therefore better able to support/brace against loads fixed to the fixing device 40). Prior to the expandable membrane 42 being disposed on the apparatus 40, the strands or filaments can be formed by pulling on the inner surface (that is, the surface facing or presenting to the internal volume of the chamber 43) of the expandable membrane 42 such that the strands protrude into the chamber 43. An alternative is to scratch the strands or filaments from the expandable membrane 42 to form the protrusions.

The chamber 43 is an internal volume of the apparatus. The chamber 43 is bounded at least partially by the expandable membrane 42, that is, a part of a wall of the chamber 43 is formed from the expandable membrane 13. The chamber 43 is configured to receive a material wherein said material can fill the chamber 43 in an unexpanded configuration (wherein the unexpanded configuration is shown schematically in FIGS. 4A and 4B and illustratively in FIG. 6). The chamber 43 can then receive further material, thereby increasing an outward pressure acting on the expandable membrane 42. Outward pressure in this instance means a pressure acting on the expandable membrane 42 resulting from a pressure gradient due to a relative high-pressure region inside the chamber 43 and a relative low-pressure region externally to the chamber 43, for example, in the void 45. This causes the expandable membrane 42 to expand outwards and accordingly increases the volume of the chamber 43 into an expanded configuration (wherein the expanded configuration is shown schematically in FIG. 4C and illustratively in FIG. 10). In the example use as a plasterboard fixing, the chamber 43 therefore expands into the void 45 behind the plasterboard 44.

The material can be any material which can be received into the chamber 43, for example, a fluid. The material can fill the chamber 43. The fixing apparatus 40 can include the material. The material can be a material which hardens, cures, or sets over time. For example, the material can be, not least for example, any one or more of: a settable material; a curable material; a resin; an adhesive medium; a fluid; an expanding fluid; a glue; an expanding glue; an expanding foam.

The material can (once hardened, cured, or set) strengthen the chamber 43 in its expanded form such that, when expanded, the chamber 43 forms a bracing structure or a support structure for securely fastening an object or load to the fixing apparatus 40 with a fastener. The material can (once hardened, cured, or set) strengthen the expandable membrane 42. The object or load could be, for example, a shelving unit, or a cupboard. Advantageously, this allows the load applied to the fixing to be dispersed over an area of the rear surface 46 of the plasterboard 44 in contact with the expanded chamber 43 because the enlarged surface area of the expanded chamber 43 abuts against the rear surface 46 of the plasterboard 44.

FIG. 5A shows an example of the housing 41 of the fixing apparatus 40 (without the expandable membrane 42 disposed thereon to aid explanation of different features) in from different viewpoints. The top-left image shows a substantially rear view, the top right image shows a substantially front view, the bottom left image shows a substantially side view, and the bottom right image shows a sectional view.

In some examples, a cross-sectional shape at a first end 51 of the housing is substantially circular, and a cross-sectional shape at a second end 52 of the housing is substantially non-circular, for example polygonal and/or comprises vertices (which may be rounded/softened vertices). An example non-circular cross-sectional shape could, for example, be a circle with smaller circles located on its circumference (as shown in the left hand side of FIG. 5B), or any other shape with any other smaller shape(s) placed on its circumference. Polygonal (which may comprise rounded/softened vertices) may comprise any one of: octagonal; heptagonal; hexagonal; pentagonal; square; or triangular (as shown in the right hand side of FIG. 5B). Advantageously, such a polygonal cross-section and/or cross section comprising vertices helps to prevent the fixing apparatus 40 spinning when inserted into a plasterboard (e.g., when a user is attempting to screw a bolt into the fixing apparatus 40). In the example shown in FIG. 5A, the cross-sectional shape at the first end 51 (shown in the top-left image) is substantially circular, and the cross-sectional shape at the second end 52 is substantially square, comprising 4 vertices. The edges of the polygonal shape may comprise a camber and/or be arched/curved (this enables a smooth transition when the user rotates the apparatus 10 when it is received and located in the fixing apparatus 40). The camber may extend along a length of the housing by, for example, a length shorter than a thickness of the plasterboard (for example, 5 mm). The housing 41 may flare out towards the second end 52. Advantageously, this helps to anchor/fix in place the fixing apparatus 40 when inserted into a plasterboard and accordingly prevent the fixing apparatus 40 being pushed through the plasterboard too far (this may additionally prevent unwanted damage to the plasterboard arising as a result of pushing the fixing apparatus in too far through the same). Said flaring may also occupy any excess space/gap in the hole drilled into the plasterboard (e.g., as a result of the user not drilling perpendicularly to the plasterboard).

In some, but not necessarily all, examples, the container 11 and/or elongate member 110 may be shaped/profiled/contoured so as to provide a complementary shape/profile/contour to the internal shape/profile/contour of the housing 41 (whether defined by circle-polygonal cross-sectional shapes or otherwise). This ensures a quick and convenient way to secure/attach the apparatus for mixing and discharging materials 10 into the fixing apparatus 40. This complementary shape/profile/contour may also restrict the possible orientations the apparatus for mixing and discharging materials 10 may be in when it inserted into the fixing apparatus 40. This ensures one or more passageways 54 in the housing 41 (described later) may be easily/accurately aligned and fully unaligned (to prevent leakage), in use, with the one or more conduits 110₂ of the elongate member 110 of the apparatus for mixing and discharging materials 10 (described later).

The housing 41 may be formed into shape from a regular cylindrical tube with a constant circular cross-sectional shape. The non-circular cross-sectional shape at the second end 52 may therefore be pulled/teased from the corresponding end of the regular cylindrical tube. Accordingly, a thickness of side walls of the housing 41 at the second end 52 may be thinner than a thickness of side walls of the housing 41 elsewhere in the housing 41. The cross-sectional shape at the second end 52 may be of larger dimensions than the cross-sectional shape of the first end/remainder of the housing 41.

The housing 41 can additionally comprise a thread on an inner surface of the housing 41. The thread may extend through the entirety of the length of the housing 41, or partially along the length of the housing 41 (as is shown in FIG. 5A). The fastener can, not least for example, be at least one of: a screw; a nail; a bolt.

The housing 41 may be formed from a single material (e.g., not least, metal, plastic), or a combination/hybrid of different materials. For example, the housing 41 can be made from plastic, and the thread 53 can be made from metal.

In some examples, the housing 41 may further comprise one or more passageways 54 to enable passage of material into the chamber 43 (not shown in FIG. 5A). As will be described later, the one or more passageways are configured to be alignable with the conduit outlets 110₂ of the apparatus 10 for mixing and discharging materials described earlier, such that material may flow from the apparatus 10 and into the fixing apparatus 40 via the conduit outlets 110₂ and passageways 54. The passageways can be in a side wall of the housing 41. The passageways 54 can be not least for example any one or more of: a channel; a passageway; a guide; a vent; a tube; a pipe.

FIG. 6 shows an example of the fixing apparatus 40 in an unexpanded configuration, namely the housing 41 shown in FIG. 5A with the expandable membrane 42 disposed thereon.

FIG. 7 shows an example of apparatus 10 for mixing and discharging materials suitable for use with a fixing apparatus 40 as previously described. In this example, the one or more conduit outlets 110₂ of the elongate member 110 may be located on side walls of the conduit 110₁. The one or more conduit outlets 110₂ may comprise one or more pairs of opposing outlets located on opposing side walls of the conduit 110₁. In this example, the conduit 110₁ has a closed end, e.g., an end distal to the container 11.

In some, but not necessarily all, examples, the one or more conduit outlets 110₂ are configured to be alignable, when the apparatus 10 for mixing and discharging material is inserted into the fixing apparatus 40, with the one or more passageways 54 in the housing 41 of the fixing apparatus 40.

In use, a user drills an elongate cavity (e.g., a through hole) into substrate 81, in this example a plasterboard. The user then inserts a fixing apparatus 40 as described into the elongate cavity in the plasterboard. The user then locates the container 11 of the apparatus 10 against the surface of the plasterboard by inserting the elongate member 110 into the housing 41 (which may be an elongate cavity). This is shown in FIG. 8.

In the event the user drills an elongate cavity (e.g., a through hole) having a major axis which is non-perpendicular to the surface of the plasterboard, the user inserting the elongate member 110 into the housing 41 and locating the container 11 against the surface of the plasterboard (e.g., a flat base of the container 11 against the surface of the plasterboard) may force the fixing apparatus 40 to be perpendicular to the surface of the plasterboard (by virtue of the flat base of the container 11 being parallel to the surface of the plasterboard). As discussed previously, after the mixing process and the expansion of the chamber 42 the material at least partially passes/leaks/oozes through the expandable membrane 42, and may fill in/mould to any damaged portions/irregularities formed as a result of forcing the fixing apparatus 40 to be perpendicular to the surface of the plasterboard.

In this example, as shown in FIGS. 7 and 8, the elongate member 110 further comprises holding means 71 configured to, in use when the elongate member 110 is received and located in the housing 41 of the fixing apparatus 40, removably hold the elongate member 110 in a held state within the housing 41 (which may be an elongate cavity), wherein the held state resists motion of the elongate member 110 in a direction along a major axis within said housing 41 (which may be an elongate cavity), demonstrated by direction 82.

In some examples, the holding means 71 comprises two curved arms in a substantial “C” shape. Each arm may comprise a thread, wherein the thread of a first arm is set a quarter turn behind the thread of a second arm. As the elongate member 110 is inserted into the housing 41 of the fixing apparatus 40, the two arms alternately engage into the thread 53 of the housing 41 and flex/ride/ratchet over the thread 53. When the elongate member 110 is fully inserted, the thread of, e.g., the first arm is engaged with the thread 53 of the housing 41 to removably hold the elongate member 110 in a held state within the housing 41, while the thread of the second arm is not engaged with the thread 53 of the housing 41.

At this stage, as demonstrated in e.g., FIG. 8, the one or more conduit outlets 110₂ are aligned with the one or more passageways 54 in the housing 41 of the fixing apparatus 40.

The user then operates the apparatus 10 for mixing and discharging materials as previously described (or, as mentioned previously, the mixing process may be done prior to insertion of the elongate member 110 into the housing 41). In this example, as shown in FIGS. 8 and 9, upon discharge of the mixed material from the apparatus 10, the mixed material is urged through the conduit outlets 110₂, then through the one or more passageways 54 in the housing 41 of the fixing apparatus 40. This causes expansion of the expandable membrane 42 as previously described.

Alternatively, the user may insert the elongate member 110 into the housing 41 of the fixing apparatus 40 prior to inserting the fixing apparatus 40 into the drilled elongate cavity in the plasterboard.

FIG. 10 shows the fully depleted/discharged apparatus 10 and the fully expanded expandable membrane 42. In this example, some of the mixed material has permeated through the expandable membrane.

At this stage, in use, to ensure no material can flow out of the chamber 43 after the apparatus 10 is fully discharged, the user rotates the apparatus 10 about an axis defined by the elongate member 110 such that the conduit outlets 110₂ are no longer in alignment with the passageways 54 in the housing 41 of the fixing apparatus 40. In some examples, a thin coating of silicone spray may be applied to an outside of the elongate member 110 to prevent the mixed material in the chamber 42 bonding with the outside of the elongate member 110. This resulting configuration of the apparatus 10 with respect to the housing 41 of the fixing apparatus 40 is shown in FIG. 11.

If the user rotates the apparatus 10 a quarter turn clockwise, because the thread of the first arm (the bottom arm from the view point of FIG. 9) of the holding means 71 is set a quarter turn behind the thread of the second arm (the top arm from the view point of FIG. 9) of the holding means 71, the first arm drops into thread with the thread 53 of the housing 41. This removably holds the elongate member 110 in the housing 41.

In this regard, the holding means 71 may be configured to, in use when the elongate member 110 is received and located in the housing 41 (which may be an elongate cavity), be rotatable about said axis (i.e., defined by the elongate member 110) within the housing 41 when the elongate member 110 is in the held state. In other words, the elongate member 110 may be rotated within the housing 41 whilst being maintained in a held state.

The user leaves the apparatus 10 and the fixing apparatus 40 in this configuration (shown in FIG. 11) until the mixed material has fully cured/set/hardened. Once cured/set/hardened, the user can remove the apparatus 10 from the fixing apparatus 40, which is now ready to receive a fastener as previously described. The depleted apparatus 40 may now be disposed of in general waste because there is no unmixed hazardous material remaining (not least by virtue of the mixing process described above).

FIG. 12 shows a sectional view of the fixing apparatus 40 in use when supporting a load 121 via a bolt 122 screwed into the thread 53 of the fixing apparatus 40.

FIGS. 13A and 13B show sectional views of further examples of a fixing apparatus 40 and an apparatus 10 for mixing and discharging materials as previously described. The example fixing apparatus 40 in FIGS. 13A and 13B may be suitable for use with a “Dot-and-Dab” plasterboard. Plasterboards set up with a “Dot-and-Dab” process are set up in front of such a wall (e.g., brick wall, breeze block etc.) with a void 131 behind the plasterboard 132 between the plasterboard 132 and the brick wall 133. For example, the brick wall 133 can be roughly 1 cm behind the plasterboard 14, that is, there can be a gap of roughly 1 cm between the plasterboard 14 and the brick wall.

In this example, a user may drill a hole through the plasterboard 132, through the void 131, and into the wall 133 behind the plasterboard. In this example, the hole through the plasterboard 132 is a through-hole, and the hole in the wall 133 behind the plasterboard is a blind hole.

In some examples, (as shown in FIGS. 13A and 13B), an additional cavity/cave/hollow/pocket 134 in the wall 133 behind the plasterboard may be formed along the length of the drilled blind hole in the wall (e.g., towards an end of the blind hole) using a wire drill using wire 139 (or other suitable drilling method). A location and/or shape and/or volume of the cavity/cave/hollow/pocket 134 in the wall 133 may be selected by the use of a guard 138 inserted into the drilled blind hole in the wall, as shown in FIG. 13C. A shape and/or cross section of the cavity/cave/hollow/pocket 134 may be tapered along a length of the cavity/cave/hollow/pocket 134. The guard 138 may further be configured to prevent damage to the plasterboard 132 and/or the wall 133 during formation of the cavity/cave/hollow/pocket. The guard 138 may further be configured to prevent unwanted expansion of the drilled hole through the plasterboard 132, through the void 131, and into the wall 133 behind the plasterboard.

The fixing apparatus 40 in this example can have an extended portion configured to be inserted through the drilled hole in the plasterboard 132 and into the drilled hole in the wall 133 behind the plasterboard 132. The fixing apparatus 40 in this example can therefore be extended such that, once fully inserted through said holes, the fixing apparatus 40 extends from an outward face 132₁ of the plasterboard, through the void 132, and into the drilled hole in the wall 133.

The one or more passageways 54 to enable passage of material into the chamber 43 of the fixing apparatus 40 in this example can comprise at least one passageway 135_{A} and 135_{B}.

The apparatus 10 for mixing and discharging materials in this example can have an extended portion of the elongate member 110 (and a corresponding extended portion of the elongate conduit 110₁) configured to be received and located and/or inserted into the extended portion of the fixing apparatus 40 of this example.

The one or more conduit outlets 110₂ to allow discharge of mixed material therefrom in this example can comprise at least one conduit outlet 136_{A} and 136_{B}.

In this example, the at least one passageways 135_{A} and 135_{B} may be configured to be alignable with the at least one conduit outlet 136_{A} and 136_{B} respectively.

In this example, the at least one passageways 135_{A} and at least one conduit outlet 136_{A} are configured, when suitably aligned as previously described, to allow material to pass therethrough, causing expansion of the expandable membrane 42 in the region of the void 131. This results in a chamber 43_{A} in the region of the void 131, as shown in FIG. 13B.

In this example, the at least one passageways 135_{B} and at least one conduit outlet 136_{B} are configured to allow material to pass therethrough, causing expansion of the expandable membrane 42 in the region of the cavity/cave/hollow/pocket 134 in the wall 133. This results in a chamber 43_{B} in the region of the cavity/cave/hollow/pocket 134 in the wall 133, as shown in FIG. 13B.

The fastener 137 (shown in FIG. 13B), once received into the extended housing 41 and fastened within the extended housing 41, will therefore extend through the plasterboard 132, across the void 131 and into the wall 133. Any load applied to the fixing apparatus 40 will therefore be transferred through to the brick wall in addition to being dispersed over the area of the rear surface of the plasterboard 132 in contact with the expanded chamber. Advantageously, the extended portion of the cavity can provide an additional bracing structure or support structure for a load applied to the plasterboard 132 fixing in addition to that provided by the expandable membrane in its expanded configuration as previously described.

An advantage of this example fixing apparatus 40 is that the expanded expandable membrane 42 in the region of the void 131 in conjunction with the expanded expandable membrane 42 in the region of the cavity/cave/hollow/pocket 134 in the wall 133, helps to prevent the plasterboard bowing/buckling/distorting towards the wall (which can look unsightly, can crack the finish on the face of the plasterboard and can even leave the load able to be unstable). In other words, in this example, the expanded expandable membrane provides a support member in the void 131 between the wall 133 and the plasterboard 132.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above. In examples a system can be provided including any of the example fixing apparatuses 40 previously described and any of the example apparatuses 10 for mixing and discharging materials previously described.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus for mixing and discharging materials, the apparatus comprising:
a container comprising a first portion for containing a first material, and a second portion for containing a second material;
a divider for dividing the first portion and the second portion, wherein the divider is further configured to separate into a first separated portion and a second separated portion; and
means for mixing configured to mix said first material and said second material to form a mixed material, wherein the means for mixing are at least one of the first and second separated portions.

2. The apparatus of claim 1, further comprising a plunger, wherein at least one of:
the plunger is configured to be engageable with a first portion of the divider such that a rotation of the plunger with respect to the container enables co-rotation of the first portion of the divider with the plunger; and
a second portion of the divider is configured to be engageable with the container such that the second portion of the divider is fixed with respect to the container.

3. The apparatus of claim 1, further comprising a plunger, wherein the plunger comprises means for locating the plunger with respect to the container.

4. The apparatus of claim 1, further comprising a plunger, wherein the plunger further comprises a spindle.

5. The apparatus of claim 4, wherein the divider further comprises a detachable member configured to at least one of:
receive and locate an end of the spindle; and
detach from the divider in response to an application of a force, by a user via the spindle, to the detachable member.

6. The apparatus of claim 1, wherein at least a portion of the divider is configured to be at least one of:
movable relative to the container;
rotatable relative to the container; and
translatable relative to the container.

7. The apparatus of claim 1, further comprising a plunger, wherein the divider is configured to at least one of: separate when a torsion in the divider reaches a predetermined threshold; and separate responsive to a rotation of the plunger.

8. The apparatus of claim 1, further comprising a plunger, wherein the divider is configured such that, when the plunger is engaged with the divider and when the divider is engaged with the container, upon application of torsion beyond a predetermined threshold, the divider separates into the first and second separated portions.

9. The apparatus of claim 1, wherein the divider comprises one or more of: a frangible portion; a weakened portion; a glued portion; a perforated line.

10. (canceled)

11. The apparatus of claim 9, wherein the means for mixing are one or more mixing members having a shape at least partially defined by the one or more of: the frangible portion; the weakened portion; the glued portion; the perforated line.

12. The apparatus of claim 1, wherein the divider is further configured to be collapsible.

13. The apparatus of claim 1, wherein the container further comprises an elongate member configured to be received and located into an elongate cavity.

14. The apparatus of claim 13, wherein the elongate member defines a conduit for passage of said mixed material therethrough, and wherein the conduit comprises one or more conduit outlets to allow discharge of said mixed material therefrom.

15. The apparatus of claim 13, wherein the elongate member further comprises holding means configured to, in use when the elongate member is received and located in said elongate cavity, removably hold the elongate member in a held state within said elongate cavity, wherein the held state resists motion of the elongate member in a direction along a major axis within said elongate cavity.

16. The apparatus of claim 15, wherein the holding means is further configured to, in use when the elongate member is received and located in said elongate cavity, be rotatable about said axis within said elongate cavity when the elongate member is in the held state.

17. The apparatus of claim 1, wherein the apparatus further comprises at least one of: the first material; the second material; and the mixed material.

18. The apparatus of claim 1, wherein at least one of:
said first material comprises a hardener;
said second material comprises one or more of an epoxy resin; a resin; a polymer; and
said mixed material comprises one or more of a non-settable material; a settable material;
a curable material; a resin; an adhesive medium; a fluid; an expanding fluid; a glue; an expanding glue; expanding foam; a medicinal substance.
